(19) United States
(12) Patent Application Publication
(10) Pub. No.: US 2018/0017246 A1
(43) Pub. Date: Jan. 18, 2018

(54) Multiple Functional Lighting Apparatus

(71) Applicant: Chi Hung LAU, Kowloon (HK)

(72) Inventor: Chi Hung LAU, Kowloon (HK)

(21) Appl. No.: 15/210,858

(22) Filed: Jul. 14, 2016

(51) Int. Cl. F21V 31/00; F21V 21/096; F21V 21/08; F21L 4/02; F21V 17/10; F21V 5/04; F21V 3/04; F21V 23/04; F21V 19/00

(52) U.S. Cl. CPC F21V 31/005; F21V 23/0428; F21V 21/0965; F21V 21/0816; F21V 19/003; F21V 17/104; F21V 5/048; F21V 3/0445; F21L 4/027; F21Y 2115/10

(57) ABSTRACT

A multiple functional lighting apparatus includes a light casing having a light opening and defining an opening rim therearound, a light module supported in the light casing for light generation through the light opening, and a light cover having a sealing rim frictionally engaged with the opening rim of the light casing in a waterproof manner to enclose the light opening thereof and to diffuse the light from the light module.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a lighting apparatus, and more particularly to a multiple functional lighting apparatus not only provides different kinds of lighting effects, but also provides waterproof configuration.

### Description of Related Arts

Conventional utility lights, such as flashlights or headlights, are widely used in different dark environment, wherein the conventional utility light normally comprises a light casing, a lighting unit supported in the light casing, and a lighting cover that covers on the lighting unit. The conventional utility lights are designed that the user is able to select different light modes with different kinds of light effects, such as spot light configuration or diffusion light configuration. Especially for outdoor usage, the conventional utility light further provides a waterproof ability. Accordingly, the lighting cover is affixed on the light casing by a sealing ring. The sealing ring is coupled at a gap between the lighting cover and the light casing, such that the sealing ring is compressed between an inner wall of the lighting cover and an outer wall of the light casing after the lighting cover is attached on the light casing. However, such waterproof structure of the sealing ring has several drawbacks.

Firstly, the sealing ring is easily to be aging and deformed after a period of usage. For example, the lighting cover is required being detached from the light casing for replacing the batteries and/or the lighting unit. Then, the lighting cover is coupled back to the light casing to bias against the sealing ring in order to sealedly couple the lighting cover at the light casing. Once the sealing ring is aged or worn, the lighting cover cannot be securely attached on the light casing. As a result, the waterproof ability of the utility lights is significantly affected, and then electronic components, such as circuit board, inside the utility lights are easily to be eroded, so as to reduce the life-span of the lighting unit. Once water or moisture enters into the light casing, the lighting unit and/or electronic components will be permanently damaged.

Secondly, the lighting cover is forced to couple the light casing for biasing against the sealing ring by an external force, such as a rotatable force. This external force will tear the sealing ring. It is worth mentioning that the user is able to select different light modes of the utility light by rotating the lighting cover. Every time when the lighting cover is rotated to change the light mode, the sealing ring will be torn. Therefore, the service life span of the sealing ring will be substantially reduced by the movement of the lighting cover.

### SUMMARY OF THE PRESENT INVENTION

The invention is advantageous in that it provides a multiple functional lighting apparatus, wherein the multiple function lighting apparatus not only provides different kinds of lighting effects, but also provides waterproof configuration.

Another advantage of the invention is to a multiple functional lighting apparatus, wherein the multiple functional lighting apparatus comprises a waterproof light cover frictionally sealed at a light casing to protect a light module supported in the light casing.

Another advantage of the invention is to provide a multiple functional lighting apparatus, wherein an engaging tongue is protruded and formed at an inner side of the sealing rim of the light cover to engage with an engaging grove indented and formed at an outer side of the opening rim of the light casing to retain the light cover at the light casing and to ensure the sealing rim to be frictionally engaged with the opening rim.

Another advantage of the invention is to provide a multiple functional lighting apparatus, wherein the multiple functional lighting apparatus comprises a light lens sealed on a light opening of the light casing to protect the light module.

Another advantage of the invention is to provide a multiple functional lighting apparatus, wherein the light module comprises a supporting platform having a light circuit printed at a bottom side of the supporting platform to form a waterproof layer on a top side of the supporting platform, so as to protect the light circuit under the waterproof layer.

Another advantage of the invention is to provide a multiple functional lighting apparatus, wherein the light circuit of the light module can be selectively activated at least three kinds of lighting effects of the LEDs.

Another advantage of the invention is to provide a multiple functional lighting apparatus, wherein the light casing comprises different attachment units for the user to use the multiple functional lighting apparatus at different situations. For example, a strap retainer is provided for the user to carry the multiple functional lighting apparatus via a fastening strap and a magnetic element is provided for being magnetically attached on any magnetic surface.

Another advantage of the invention is to provide a multiple functional lighting apparatus, wherein a lower frame of the outer frame comprises a magnet adapted to allow the multiple functional lighting apparatus being attached on any kinds of magnetic surface.

Another advantage of the invention is to provide a multiple functional lighting apparatus, wherein the light cover can be shifted between a concave position and a convex position, so as to provide different light effects.

Another object of the present invention is to provide a multiple functional lighting apparatus, which does not require to alter the original structural design of lighting apparatus, so as to minimize the manufacturing cost of the light module incorporating in the multiple functional lighting apparatus.

Another object of the present invention is to provide a multiple functional lighting apparatus, wherein no expensive or complicated structure is required to employ in the present invention in order to achieve the above mentioned objects. Therefore, the present invention successfully provides an economic and efficient solution for providing a waterproof feature of the multiple functional lighting apparatus.

Additional advantages and features of the invention will become apparent from the description which follows, and may be realized by means of the instrumentalities and combinations particular point out in the appended claims.

According to the present invention, the foregoing and other objects and advantages are attained by a multiple functional lighting apparatus, comprising:

a light casing having a light opening and defining an opening rim therearound;

a light module supported in the light casing for light generation through the light opening; and

a light cover having a sealing rim frictionally engaged with the opening rim of the light casing in a waterproof manner to enclose the light opening thereof and to diffuse the light from the light module.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a multiple functional lighting apparatus according to a first preferred embodiment of the present invention.

FIG. 2 is an exploded perspective view of the multiple functional lighting apparatus according to the above first preferred embodiment of the present invention.

FIG. 3 is a sectional view of the multiple functional lighting apparatus according to the above first preferred embodiment of the present invention, illustrating the switch extension portion of the light cover extended into the operation slot to contact with the light switch.

FIG. 4 is an exploded view of a multiple functional lighting apparatus according to a second preferred embodiment of the present invention.

FIG. 5 is a sectional view of the multiple functional lighting apparatus according to the above second preferred embodiment of the present invention.

FIG. 6A is a sectional view of the multiple functional lighting apparatus according to the above second preferred embodiment of the present invention, illustrating the light cover at the convex position.

FIG. 6B is a sectional view of the multiple functional lighting apparatus according to the above second preferred embodiment of the present invention, illustrating the light cover at the concave position.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

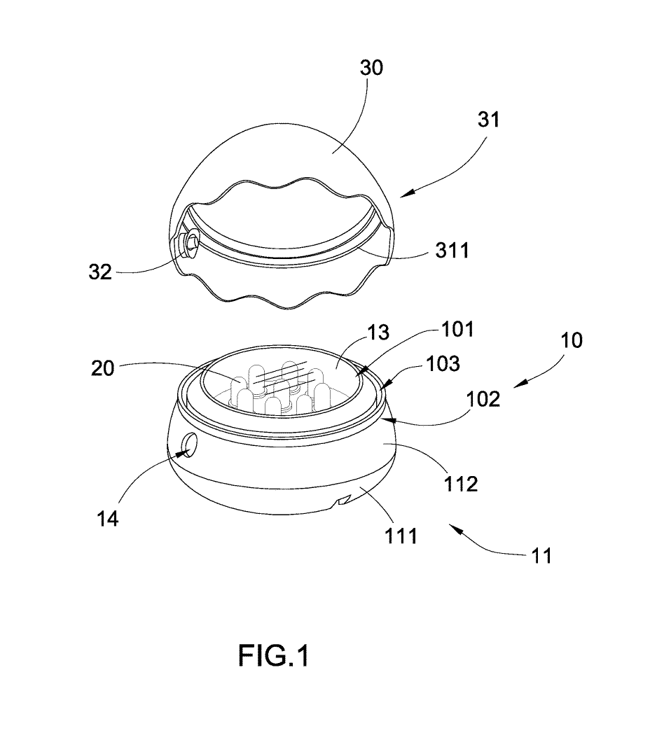

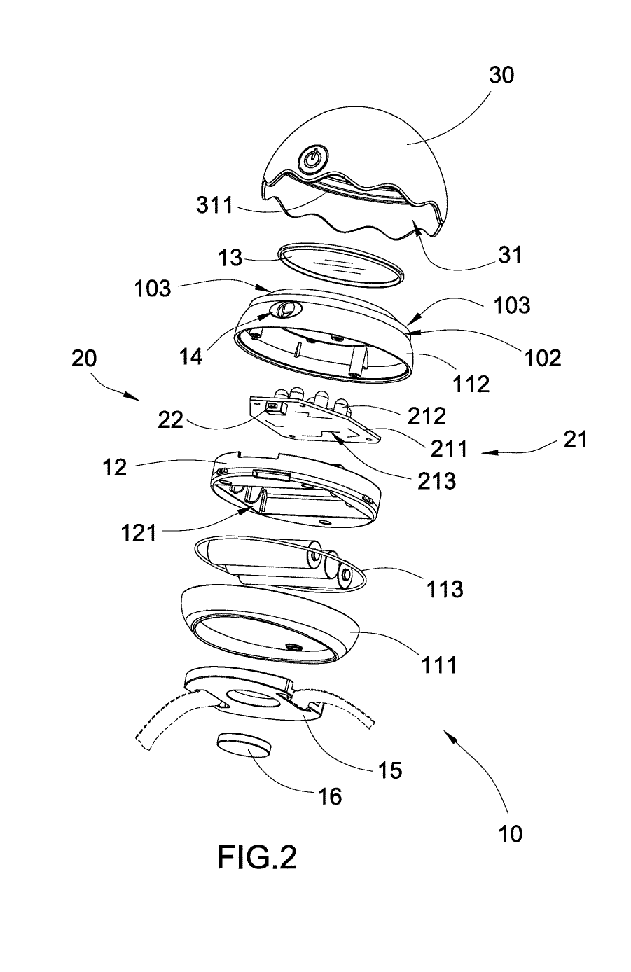

Referring to FIGS. 1 and 2 of the drawings, a multiple functional lighting apparatus according to a first preferred embodiment of the present invention is illustrated, wherein the multiple functional lighting apparatus of the first embodiment is embodied as a hand-free light apparatus. The multiple functional lighting apparatus comprises a light casing 10, a light module 20 supported in the light casing 10, and a light cover 30 attached to the light casing 10.

As shown in FIGS. 1 and 2, the light casing 10 has a light opening 101 and defining an opening rim 102 therearound. According to the first embodiment, the light casing 10 comprises an outer casing frame 11 and an inner casing frame 12 received therein.

The outer casing frame 11 comprises a bottom casing body 111 and a top annular casing body 112 detachably coupled at the bottom casing body 111 to receive the inner casing frame 12 therebetween, wherein the light opening 101 is formed at the top annular casing body 112. Preferably, a sealing ring 113 is provided between an engagement between the bottom casing body 111 and the top annular casing body 112.

The inner casing frame 12 has a top side that supports the light module 20 thereon and a bottom side defining a battery cavity 121 thereat for receiving at least a battery to electrically connect to the light module 20. Accordingly, the inner casing frame 12 is disposed at the bottom casing body 111 to enclose the battery cavity 121 between the bottom side of the inner casing frame 12 and a bottom wall of the bottom casing body 111. When the top annular casing body 112 is coupled to the bottom casing body 111, the inner casing frame 12 is retained between the top annular casing body 112 and the bottom casing body 111 at a position that the light module 20 is aligned with the light opening 101 at the top annular casing body 112. Preferably, one or more rechargeable batteries or replaceable batteries are received in the battery cavity 121 to electrically connect to the light module 20.

As shown in FIG. 2, the light module 20 comprises a light unit 21 disposed at the opening rim 102 of the light casing 10 and a light switch 22 received in the light casing 10 to operatively link to the light unit 21. The light unit 21 comprises a supporting platform 211, at least one LED 212 coupled on a top side of the supporting platform 211 that faces towards the light opening 101, and a light circuit 213 printed on a bottom side of the supporting platform 211 to electrically connect with the LED 212.

According to the first embodiment, the supporting platform 211 is made of waterproof material, wherein the top side of the supporting platform 211 forms a waterproof layer to support the LED 212. Preferably, a plurality of LEDs 212 are spacedly coupled at the supporting platform 211, wherein a head portion of the LED 212 is sealed and mounted on the top side of the supporting platform 211 and a terminal portion of the LED 212 is extended through the supporting platform 211 to electrically connect to the light circuit 213. Therefore, the light circuit 213 is protected by the supporting platform 211 to prevent water damage of the light circuit 213.

In addition, the light switch 22 is supported by the supporting platform 211 to electrically connect with the light circuit 213. Accordingly, the light circuit 213 is configured to control the LEDs 212 in an on-and-off manner and to selectively control different light effects of the LEDs 212 via the light switch 22. In one embodiment, the light switch 22 is press-control switch 22, wherein when the light switch 22 is pressed once, the LEDs 212 are switched on for bright light generation, such as 100% full light intensity. When the light switch 22 is pressed again, the LEDs 212 are activated for dim light generation, such as 50% light intensity. When the light switch 22 is pressed at the third time, the LEDs 212 are activated for generating a blinking light effect. When the light switch 22 is pressed at the fourth time, the LEDs 212 are deactivated for stop generating light. It is appreciated that different light effects can be configured via the light circuit 213, such as generating different light colors by the LEDs 212.

As shown in FIGS. 1 and 2, the light cover 30, which is made of light transmissible material, has a sealing rim 31 frictionally engaged with the opening rim 102 of the light casing 10 in a waterproof manner to enclose the light opening 101 thereof and to diffuse the light from the light module 20. Accordingly, the light cover 30, which is made of waterproof and elastic materials. Preferably, the light cover 30 is made of flexible silicon. The light cover 30 can be easily attached and detached from the light casing 10 by hand intentionally, such that no additional accessory is required to install the light cover 30 to the light casing 10. It is worth mentioning that the light cover 30 is made of unbreakable material due to its flexibility, such that when the light cover 30 is fallen on a ground, the light cover 30 will not be broken or damage so as to prolong the service life span of the light cover 30.

The light cover 30 has a hemispherical shape defining the sealing rim 31 at a bottom edge portion of the light cover 30, such that when the light is generated by the LEDs 212 of the light module 20, the light will project to the light cover 30 and will diffuse through the light cover 30. Preferably, an inner side of the sealing rim 31 of the light cover 30 is frictionally engaged with an outer side of the opening rim 102 of the light casing 10.

The light casing 10 further has an engaging groove 103 indented and formed at the outer side of the opening rim 102 of the light casing 10. The light cover 30 further has an engaging tongue 311 protruded and formed at the inner side of the sealing rim 31 of the light cover 30. Accordingly, the engaging tongue 311 is engaged with the engaging groove 103 to retain the light cover 30 at the light casing 10 and to ensure the sealing rim 31 to be frictionally engaged with the opening rim 102. In other words, the interlocking engagement between the engaging tongue 311 and the engaging groove 103 will ensure the attachment between the light cover 30 and the light casing 10 and will ensure the frictionally engagement between the sealing rim 31 and the opening rim 102. It is appreciated that the engaging tongue 311 can be protruded from the outer side of the opening rim 102 of the light casing 10 and the engaging groove 103 can be indented at the inner side of the sealing rim 31 of the light cover 30 for interlocking engagement.

In particular, the engaging groove 103 is indented and formed at the outer side of the opening rim 102 of the top annular casing body 112 of the light casing 10, wherein the sealing rim 31 of the light cover 30 is frictionally engaged with the top annular casing body 112.

The light casing 10 further comprises a light lens 13, which is made of transparent material, coupled at the light opening 101 of the light casing 10 to seal and enclose the light module 20. In particular, the light lens 13 is coupled at the top annular casing body 112 of the light casing 10. Therefore, both the light cover 30 and the light lens 13 provide a double waterproof ability for the multiple functional lighting apparatus of the present invention.

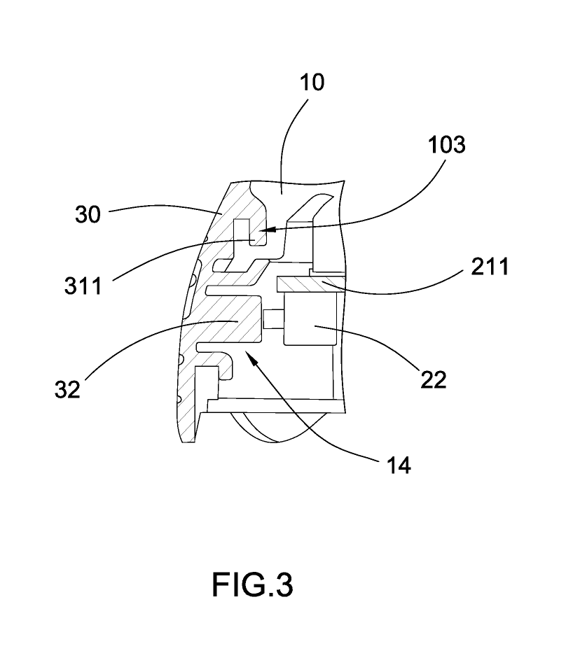

In order to access the light switch 22 within the light casing 10, the light casing 10 further has an operation slot 14 formed thereat to align with the light switch 22 within the light casing 10. Since the operation slot 14 is a through hole formed at a surrounding wall of the light casing 10 to communicate with an interior thereof, water or moisture will enter into the light casing 10. In order to prevent the water or moisture entering into the light casing 10, the light cover 30 further has a switch extension portion 32 integrally extended from the sealing rim 31 to seal and cover the light switch 22. As shown in FIG. 3, the switch extension portion 32 is protruded from the inner side of the light cover 30 to slidably insert into the operation slot 14 and to contact with the light switch 22. Therefore, the operation slot 14 is sealed by the switch extension portion 32 of the light cover 30. Since the light cover 30 is made of flexible material, the user is able to press the switch extension portion 32 of the light cover 30 to actuate the light switch 22. It is worth mentioning that the engagement between the switch extension portion 32 and the operation slot 14 not only forms an actuation for the light module 20 but also serves as a positioning means to retain the corrected alignment between the light cover 30 and the light casing 10. In other words, in order to detach the light cover 30 from the light casing 10, the switch extension portion 32 of the light cover 30 must be disengaged with the operation slot 14. Therefore, the engagement between the switch extension portion 32 and the operation slot 14 will prevent the light cover 30 from being detached from the light casing 10 accidentally.

As it is mentioned above, the multiple functional lighting apparatus of the first embodiment is a hand free lighting apparatus. The light casing 10 further comprises a strap retainer 15 coupled at a bottom side of the bottom casing body 111 for retaining a fastening strap, and a magnetic element 16 embedded at the strap retainer 15. Accordingly, the fastening strap, especially the length-adjustable strap, can be detachably coupled to the light casing 10 via the strap retainer 15. The multiple functional lighting apparatus can serve as a camping light by using a shorter fastening strap to hang the multiple functional lighting apparatus at the tent. The multiple functional lighting apparatus can serve as a head lamp by using a longer fastening strap to be worn at the head of the user. The multiple functional lighting apparatus can also be attached onto the cloth of the user. The magnetic element 16 is embedded at the strap retainer 15 at the center of the light casing 10. It is appreciated that the magnetic element 16 can be directly coupled at the bottom side of the bottom casing body 111. The magnetic element 16 is arranged for magnetically mounting on any magnetically attracting surface, such as vehicle surface, helmet surface, or refrigerator surface, such that the multiple functional lighting apparatus can serve as a closet light, safety light, deposit light, or emergency light via the magnetic element 16. In addition, the magnetic element 16 is also magnetically attracted with the battery within the battery cavity 121 to retain the inner casing frame 12 at the bottom wall of the bottom casing body 111 so as to prevent any vibration of the inner casing frame 12 at the bottom casing body 111. Therefore, the magnetic element 16 provides multiple functions not only for magnetically mounting the multiple functional lighting apparatus on the surface but also for magnetically holding the inner casing frame 12 at the bottom casing body 111.

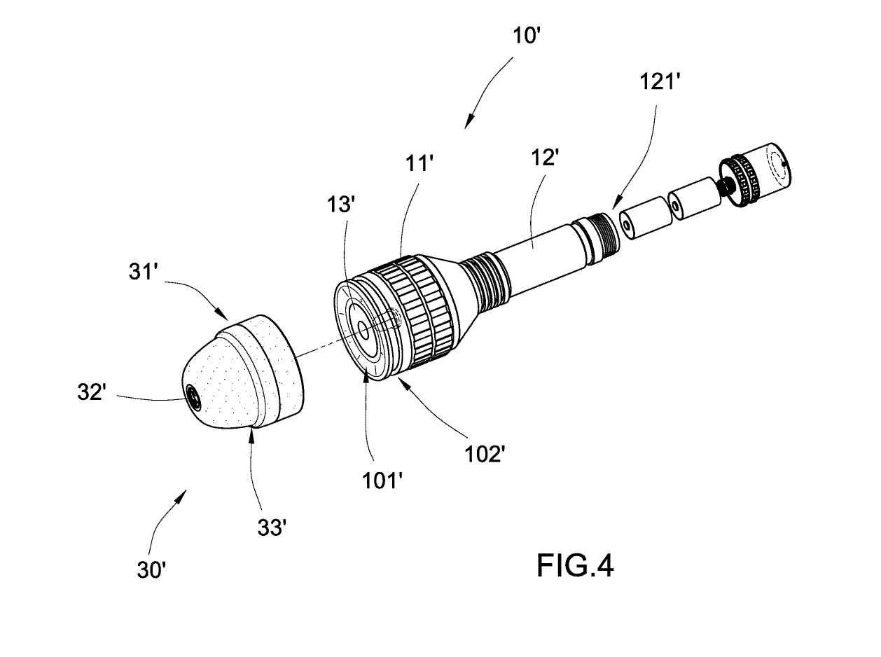

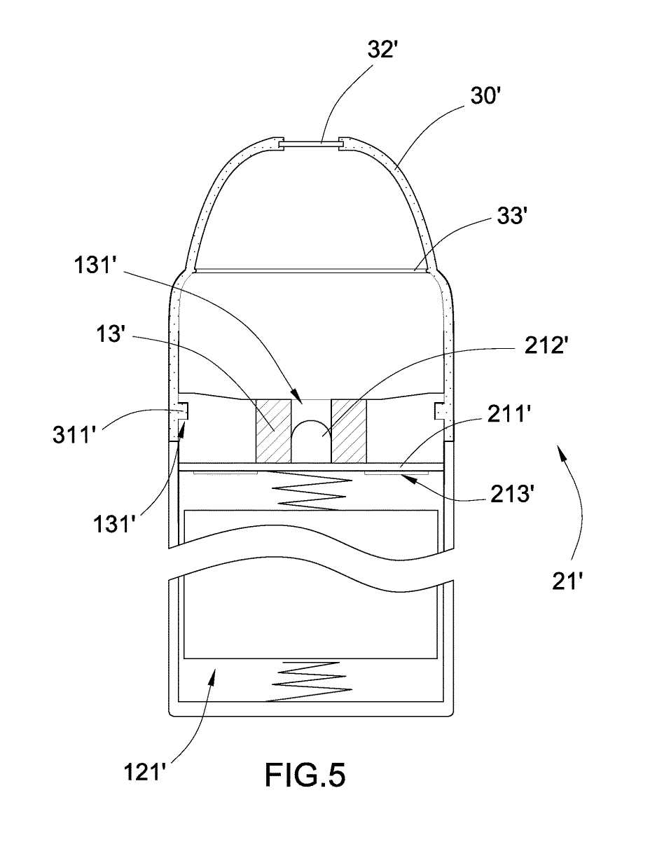

As shown in FIGS. 4 and 5, a multiple functional lighting apparatus according to a second embodiment of the present invention illustrates an alternative mode of the first embodiment, wherein the multiple functional lighting apparatus is embodied as a flash light. The multiple functional lighting apparatus of the second embodiment comprises a light casing 10′, a light module 20′ supported in the light casing 10′, and a light cover 30′ attached to the light casing 10′.

The light casing 10′ has a light opening 101′ and defining an opening rim 102′ therearound. The light casing 10′ comprises a casing head 11′ defining the light opening 101′ thereat, and a casing handle 12′ detachably coupled at the casing head 11′, wherein the light module 20′ is supported within the casing head 11′ and the casing handle 12′ has a battery cavity 121′ for receiving at least a battery to electrically connect to the light module 20′.

As shown in FIG. 5, the light module 20′ comprises a light unit 21′ disposed at the opening rim 102′ of the casing head 11′ of the light casing 10′ and a light switch 22′ provided at the casing handle 12′ of the light casing 10′ to operatively link to the light unit 21′. The light unit 21′ comprises a supporting platform 211′, at least one LED 212′ coupled on a top side of the supporting platform 211′ that faces towards the light opening 101, and a light circuit 213′ printed on a bottom side of the supporting platform 211′ to electrically connect with the LED 212′.

According to the second embodiment, the supporting platform 211′ is made of waterproof material, wherein the top side of the supporting platform 211′ forms a waterproof layer to support the LED 212′. Preferably, one LED 212′ is coupled at the supporting platform 211′, wherein a head portion of the LED 212′ is sealed and mounted on the top side of the supporting platform 211′ and a terminal portion of the LED 212′ is extended through the supporting platform 211′ to electrically connect to the light circuit 213′. Therefore, the light circuit 213′ is protected by the supporting platform 211′ to prevent water damage of the light circuit 213′. The light switch 22′ is supported at a bottom end of the casing handle 12′ to electrically connect with the light circuit 213. Accordingly, the light circuit 213′ is configured to control the LED 212′ in an on-and-off manner and to selectively control different light effects of the LED 212′ via the light switch 22′.

The light casing 10′ further comprises a light lens 13′, which is made of transparent material, coupled at the light opening 101′ of the light casing 10′ to seal and enclose the light module 20′. In particular, the light lens 13′ is coupled at the casing head 11′ of the light casing 10′, wherein the light lens 13′ has a through light channel 131′, such that the head portion of the LED 212′ is sealed with and embedded in the light channel 131′ of the light lens 13′. Therefore, both the light cover 30′ and the light lens 13′ provide a double waterproof ability for the multiple functional lighting apparatus of the present invention.

The light cover 30′, which is made of light transmissible material, has a sealing rim 31′ frictionally engaged with the opening rim 102′ of the light casing 10′ in a waterproof manner to enclose the light opening 101′ thereof and to diffuse the light from the light module 20′. Accordingly, the light cover 30′, which is made of waterproof and elastic materials. Preferably, the light cover 30′ is made of flexible silicon. The light cover 30′ can be easily attached and detached from the light casing 10′ by hand intentionally, such that no additional accessory is required to install the light cover 30 to the light casing 10′.

The light cover 30′ has a conical shape defining the sealing rim 31′ at a bottom edge portion of the light cover 30′, such that when the light is generated by the LED 212′ of the light module 20′, the light will project to the light cover 30′ and will diffuse through the light cover 30′. Preferably, an inner side of the sealing rim 31′ of the light cover 30′ is frictionally engaged with an outer side of the opening rim 102′ of the light casing 10′.

The light casing 10′ further has an engaging groove 103′ indented and formed at the outer side of the opening rim 102′ of the light casing 10′. The light cover 30′ further has an engaging tongue 311′ protruded and formed at the inner side of the sealing rim 31′ of the light cover 30′. Accordingly, the engaging tongue 311′ is engaged with the engaging groove 103′ to retain the light cover 30′ at the light casing 10′ and to ensure the sealing rim 31′ to be frictionally engaged with the opening rim 102′. In particular, the engaging groove 103′ is indented and formed at the outer side of the opening rim 102′ of the casing head 11′ of the light casing 10′, wherein the sealing rim 31′ of the light cover 30′ is frictionally engaged with the casing head 11′.

According to the second embodiment, the light cover 30′ is shifted between a first protrusion position, i.e. a convex position, and a second indention position, i.e. a concave position. At the first protrusion position, an apex of the light cover 30′ is shifted away from the light module 20′, such that the distance between the apex of the light cover 30′ and the LED 212′ is maximized. At the second indention position, the light cover 30′ is pressed to move the apex of the light cover 30′ close to the light module 20′, such that the distance between the apex of the light cover 30′ and the LED 212′ is minimized. In other words, the light cover 30′ is shifted between the first protrusion position and the second indention position for selectively controlling different light effects from the light module 20′.

The light cover 30′ further comprises a cover lens 32′ formed at the apex, wherein the cover lens 32′ is made of transparent material, such that the cover lens 32′ is moved away from the light module 20′ at the first protrusion position and is moved close to the light module 20′ at the second indention position. It is worth mentioning that the cover lens 32′ is coaxially aligned with the LED 212′ when the light cover 30′ is moved at the first protrusion position and at the second indention position.

The light cover 30′ further comprises an annular rib 33′ formed at an inner side thereof to allow an upper conical portion of the light cover 30′ to be shifted between the first protrusion position and the second indention position. Accordingly, the annular rib 33′ serves as a guidance to shift the upper conical portion of the light cover 30′ between the first protrusion position and the second indention position.

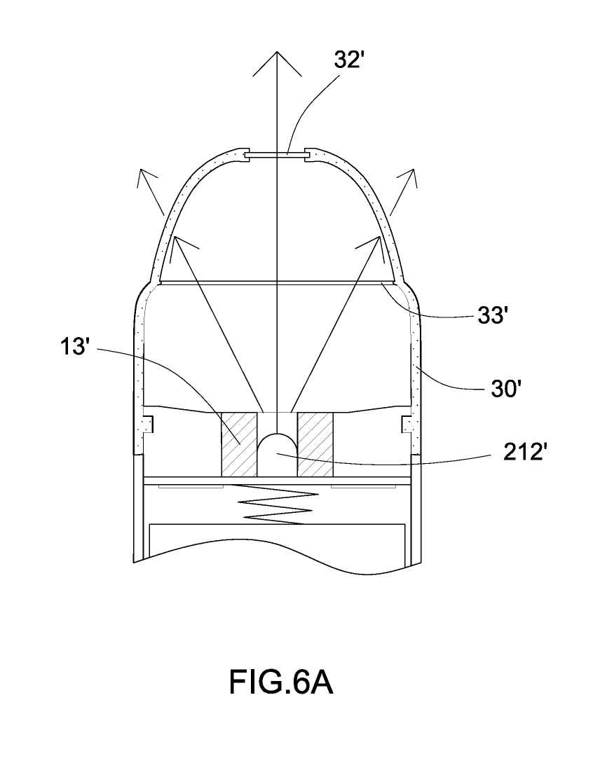

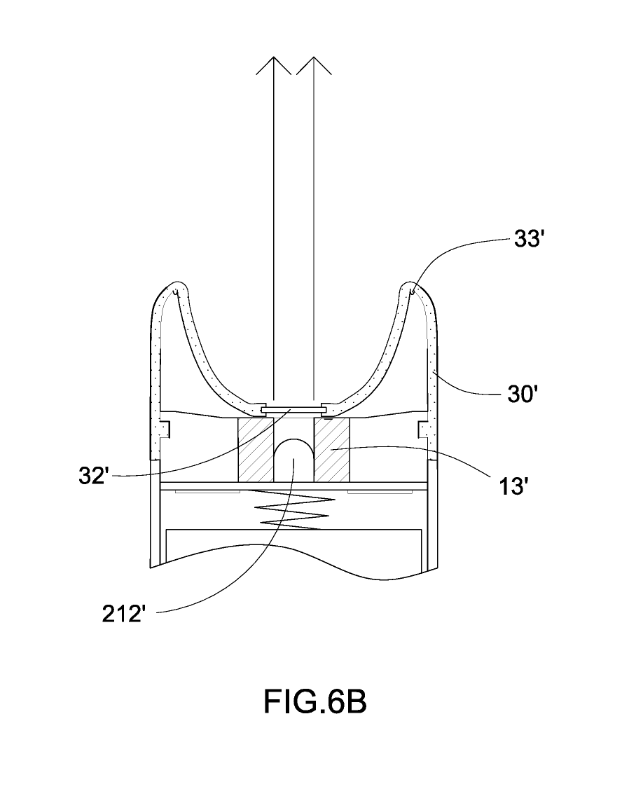

As shown in FIG. 6A, when the light cover 30′ is moved at the first protrusion position, the cover lens 32′ is moved away from the light module 20′, such that a portion of the light from the light module 20′ will project to the cover lens 32′ and a portion of the light from the light module 20′ will project to the inner side of the light cover 30′. Therefore, the multiple functional lighting apparatus serves as an area light apparatus. As shown in FIG. 6B, when the light cover 30′ is moved at the second indention position, the cover lens 32′ is moved close to the light module 20′, such that the light from the light module 20′ will project to the cover lens 32′. The multiple functional lighting apparatus serves as a beam light apparatus or a spot light apparatus. It is worth mentioning that an external force can be applied on the light cover 30′ by hand to move the light cover 30′ between the first protrusion position and the second indention position since the light cover 30′ is made of elastic material. Therefore, the user is able to move the light cover 30′ between the first protrusion position and the second indention position without detaching the light cover 30′ from the light casing 10′.

According to the first and second embodiment, the manufacturers and/or the users are able to interchange the light cover 30, 30′ to provide different light effects. When the light cover 30, 30′ is made of transparent material, the light can be highly transmitted through the light cover 30, 30′. When the light cover 30, 30′ is made of translucent material, the light can be diffused through the light cover 30, 30′. It is appreciated that the light cover 30, 30′ can be incorporated with an existing light apparatus to provide an add-on waterproof ability therefor.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A multiple functional lighting apparatus, comprising:
a light casing having a light opening and defining an opening rim therearound;
a light module supported in said light casing for light generation through said light opening; and
a light cover having a sealing rim frictionally engaged with said opening rim of said light casing in a waterproof manner to enclose said light opening thereof and to diffuse the light from said light module.

2. The multiple functional lighting apparatus, as recited in claim 1, wherein said light casing further has an engaging groove indented and formed at an outer side of said opening rim of said light casing, wherein said light cover further has an engaging tongue protruded and formed at an inner side of said sealing rim of said light cover that said engaging tongue is engaged with said engaging groove to retain said light cover at said light casing and to ensure said sealing rim to be frictionally engaged with said opening rim.

3. The multiple functional lighting apparatus, as recited in claim 1, wherein said light cover is made of flexible silicon.

4. The multiple functional lighting apparatus, as recited in claim 2, wherein said light cover is made of flexible silicon.

5. The multiple functional lighting apparatus, as recited in claim 1, wherein said light module comprises a light unit disposed at said opening rim of said light casing and a light switch received in said light casing to operatively link to said light unit, wherein said light cover further comprises a switch extension portion integrally extended from said sealing rim to seal and cover said light switch.

6. The multiple functional lighting apparatus, as recited in claim 4, wherein said light module comprises a light unit disposed at said opening rim of said light casing and a light switch received in said light casing to operatively link to said light unit, wherein said light cover further comprises a switch extension portion integrally extended from said sealing rim to seal and cover said light switch.

7. The multiple functional lighting apparatus, as recited in claim 5, wherein said light casing further has an operation slot formed thereat to align with said light switch within said light casing, wherein said switch extension portion of said light cover is extended into said operation slot to contact with said light switch.

8. The multiple functional lighting apparatus, as recited in claim 6, wherein said light casing further has an operation slot formed thereat to align with said light switch within said light casing, wherein said switch extension portion of said light cover is extended into said operation slot to contact with said light switch.

9. The multiple functional lighting apparatus, as recited in claim 6, wherein said light unit comprises a supporting platform, at least one LED coupled on a top side of said supporting platform that faces towards said light opening, and a light circuit printed on a bottom side of said supporting platform to electrically connect with said LED.

10. The multiple functional lighting apparatus, as recited in claim 8, wherein said light unit comprises a supporting platform, at least one LED coupled on a top side of said supporting platform that faces towards said light opening, and a light circuit printed on a bottom side of said supporting platform to electrically connect with said LED.

11. The multiple functional lighting apparatus, as recited in claim 1, wherein said light casing comprises an outer casing frame and an inner casing frame received therein, wherein said inner casing frame has a top side that supports said light module thereon and a bottom side defining a battery cavity thereat for receiving at least a battery to electrically connect to said light module.

12. The multiple functional lighting apparatus, as recited in claim 10, wherein said light casing comprises an outer casing frame and an inner casing frame received therein, wherein said inner casing frame has a top side that supports said light module thereon and a bottom side defining a battery cavity thereat for receiving at least a battery to electrically connect to said light module.

13. The multiple functional lighting apparatus, as recited in claim 11, wherein said outer casing frame comprises a bottom casing body and a top annular casing body detachably coupled at said bottom casing body to receive said inner casing frame therebetween, wherein said light opening is formed at said top annular casing body and said sealing rim of said light cover is frictionally engaged with said top annular casing body.

14. The multiple functional lighting apparatus, as recited in claim 12, wherein said outer casing frame comprises a bottom casing body and a top annular casing body detachably coupled at said bottom casing body to receive said inner casing frame therebetween, wherein said light opening is formed at said top annular casing body and said sealing rim of said light cover is frictionally engaged with said top annular casing body.

15. The multiple functional lighting apparatus, as recited in claim 13, wherein said light casing further comprises a strap retainer coupled at a bottom side of said bottom casing body for retaining a fastening strap, and a magnetic element embedded at said strap retainer for magnetically attracting with the battery within said battery cavity.

16. The multiple functional lighting apparatus, as recited in claim 14, wherein said light casing further comprises a strap retainer coupled at a bottom side of said bottom casing body for retaining a fastening strap, and a magnetic element embedded at said strap retainer for magnetically attracting with the battery within said battery cavity.

17. The multiple functional lighting apparatus, as recited in claim 4, wherein said light cover has a conical shape being shifted between a first protrusion position that an apex of said light cover is shifted away from said light module and a second indention position that said light cover is pressed to move said apex of said light cover close to said light module for selectively controlling different light effects from said light module.

18. The multiple functional lighting apparatus, as recited in claim 17, wherein said light cover further has an annular rib formed at an inner side thereof to allow an upper conical portion of said light cover to be shifted between said first protrusion position and said second indention position.

19. The multiple functional lighting apparatus, as recited in claim 18, wherein said light cover further comprises a cover lens formed at said apex, such that said cover lens is moved away from said light module at said first protrusion position and is moved close to said light module at said second indention position.

20. The multiple functional lighting apparatus, as recited in claim 17, wherein said light unit comprises a supporting platform, at least one LED coupled on a top side of said supporting platform that faces towards said light opening, and a light circuit printed on a bottom side of said supporting platform to electrically connect with said LED.

21. The multiple functional lighting apparatus, as recited in claim 19, wherein said light unit comprises a supporting platform, at least one LED coupled on a top side of said supporting platform that faces towards said light opening, and a light circuit printed on a bottom side of said supporting platform to electrically connect with said LED.

22. The multiple functional lighting apparatus, as recited in claim 20, wherein said light casing further comprises a light lens, having at least a through light channel, mounted at said light opening at a position that a head portion of said LED is sealed with and embedded in said light channel of said light lens.

23. The multiple functional lighting apparatus, as recited in claim 21, wherein said light casing further comprises a light lens, having at least a through light channel, mounted at said light opening at a position that a head portion of said LED is sealed with and embedded in said light channel of said light lens.

24. The multiple functional lighting apparatus, as recited in claim 22, wherein said light casing further comprises a casing head defining said light opening thereat, and a casing handle detachably coupled at said casing head, wherein said light module is supported within said casing head and said casing handle has a battery cavity for receiving at least a battery to electrically connect to said light module.

25. The multiple functional lighting apparatus, as recited in claim 23, wherein said light casing further comprises a casing head defining said light opening thereat, and a casing handle detachably coupled at said casing head, wherein said light module is supported within said casing head and said casing handle has a battery cavity for receiving at least a battery to electrically connect to said light module.
